(19) United States
(12) Patent Application Publication
(10) Pub. No.: US 2008/0205033 A1
(43) Pub. Date: Aug. 28, 2008

(54) Lighting Apparatus for Biological and Medical Purposes

(75) Inventors: Matthias Born, Geldern (DE); Thomas Justel, Witten (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/912,160

(22) PCT Filed: Apr. 13, 2006
(86) PCT No.: PCT/IB06/51160

§ 371 Date: Oct. 22, 2007

(30) Foreign Application Priority Data
Apr. 21, 2005 (EP) 05103207.6

(51) Int. Cl. F21V 9/16

(52) U.S. Cl. 362/84

(57) ABSTRACT

The lighting apparatus according to the invention comprises one or several light sources and a light guide including a light outcoupling structure. The lighting apparatus emits light between 280 and 800 nanometers. It is an object of the invention to provide an improved apparatus for scientific and therapeutic purposes with a light source of planar structure, which can be optimally adapted to an exposed area. This is achieved by light sources or parts of them being easily replaceable. The light sources may be fluorescent lamps based on an Hg, Ne, Xe or Xe/Ne discharge or they may also be LEDs.

The invention relates to a lighting apparatus comprising one or several light sources and a light guide including a light outcoupling structure, the lighting apparatus emitting light between 280 and 400 nm. In particular the lighting apparatus includes light sources, which emit UV radiation and visible light and are suitable for scientific and therapeutic purposes.

UV and visible light emitting radiation sources are widely applied for scientific, medical and cosmetic purposes, e.g. acne, psoriasis and jaundice treatment or tanning. A main drawback of the presently available light sources is their poor quality in sense of their lack of uniform intensity of the light radiation upon an affected area and their restriction in terms of available spectra, which is determined by the type of lamp mounted inside the light source. In most cases only one type of lamp is mounted inside the light source, and most commonly applied lamps are fluorescent lamps or LED's. Therefore, the achievable spectra of the radiation source are determined by the commercially available fluorescent lamps and LED's. Due to the lack of suitable and highly specific light sources, most of the photobiological experiments result in conclusions, which are less precise compared to those from experiments, in which light sources emit spectra optimally adapted to the photobiological processes. For many application areas, e.g. biological or medical research, it is highly desirable to have a light source emitting a spectrum which is optimally adapted to flexible scientific investigation.

To overcome the problem of variable intensities a simple measure would be to distance the light source from a treated area with the disadvantage of decreasing intensity. In EP 1 482 535 there is introduced a phototherapeutic device comprising an ultraviolet ray source of planar structure which provides a uniform intensity of the light radiation upon an affected area.

It is an object of the invention to provide an improved lighting apparatus for scientific and therapeutic purposes with a light source of planar structure which can be optimally adapted to an exposed area.

The object is achieved by a lighting apparatus comprising one or several light sources in a planar structure and a light guide including a light outcoupling structure, the lighting apparatus emitting light between 280 and 400 nm, characterized in that the light sources or parts of them are flexibly mounted on the lighting apparatus.

Preferred embodiments are listed in the subclaims.

The present invention will become apparent from the following description with reference to the accompanying drawings which illustrate examples of the invention.

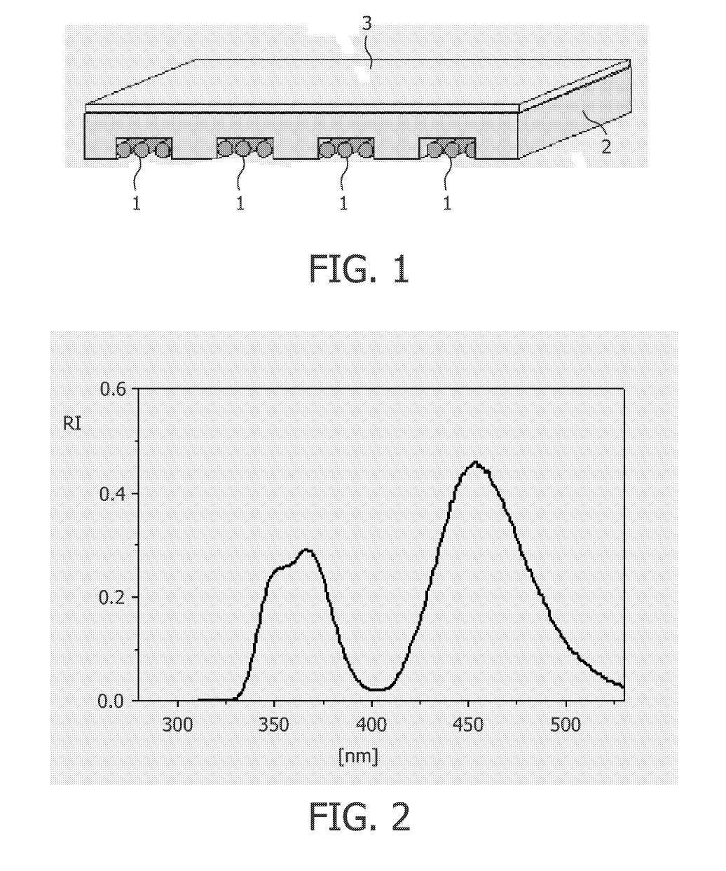

FIG. 1 shows schematically a cross section through four flexibly mounted Hg low-pressure lamps 1 representing the flat light sources which are easy to replace, further a light guide 2 and a luminescent screen 3.

FIG. 2 shows the spectrum of a DB (dielectric barrier) Xe excimer discharge lamp with a luminescent screen comprising a composition of 90% LaPO₄:Ce and 10% BaMgAl₁₀O₇:Eu in 290 glass. The axis of abscissae represents the wavelength in nanometers and the axis of ordinates represents the relative intensity RI. Peaks of RI appear at about 370 nm and 450 nm. The corresponding light source also comprises a flat light guiding tile coated by a SiO₂ nanoparticle based outcoupling structure.

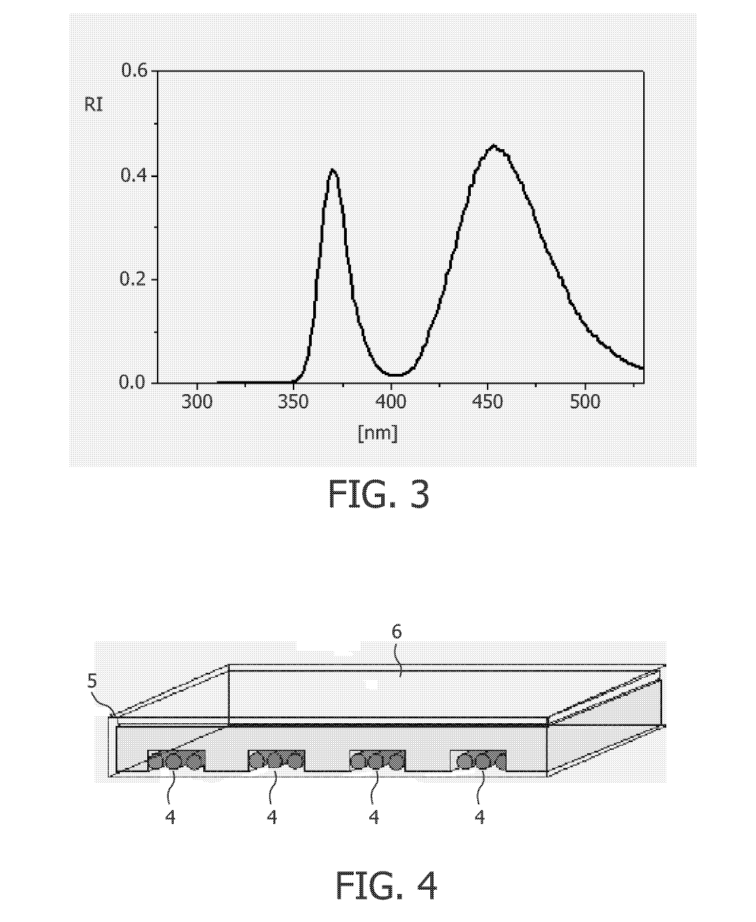

FIG. 3 shows the spectrum of a DB Xe excimer discharge lamp with a luminescent screen comprising a composition of 80% SrB₄O₇:Eu and 20% BaMgAl₁₀O₇:Eu in 290 glass. The axis of abscissae represents the wavelength in nanometers and the axis of ordinates represents the relative intensity RI. Peaks of RI appear at about 370 nm and 450 nm. The corresponding light source also comprises a flat light guiding tile coated by a SiO₂ nanoparticle based outcoupling structure.

FIG. 4 is a schematic illustration of a cross section through four flexibly mounted DB Xe excimer discharge lamps 4 in a casing 5 representing the flat light sources which are easy to replace and a light outcoupling structure 6 incorporating a diffuser.

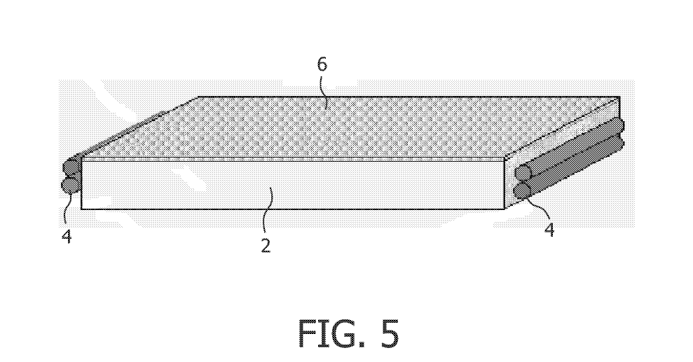

FIG. 5 is a schematic illustration of a cross section through two flexibly mounted DB Xe excimer discharge lamps 4 in an alternative arrangement representing the flat light sources which are easy to replace, further a light guide 2 and a light outcoupling structure 6 incorporating a diffuser.

The lighting apparatus according to the invention comprises one or several light sources in a planar structure and a light guide including a light outcoupling structure. The light guide comprises an outcoupling structure to achieve even and homogeneous light outcoupling. The lighting apparatus emits light between 280 and 400 nm and is characterized in that the light sources or parts of them are flexibly mounted on the lighting apparatus. This way it is possible to adapt the lighting apparatus source to an exposed area by mounting the adequate light source on the apparatus.

According to a preferred embodiment the lighting apparatus comprises one or several fluorescent lamps as light sources.

The fluorescent lamps are preferably based on a low or medium pressure Hg, Ne, Xe or Xe/Ne discharge whereby either the inner or outer side of the lamp glass is coated by a luminescent screen or the luminescent screen is applied onto a light guide, which is part of the light source. The discharge lamp is either an UV emitting lamp in quartz glass or a UV/VIS (Ultraviolet Visible) lamp in soda lime glass equipped by a luminescent screen that comprises one or several luminescent materials whereby at least one of the phosphors emits light between 280 and 400 nm.

By having a set of replaceable lamps and/or a set of replaceable luminescent screens with different spectra between 280 and 800 nm, the emission spectrum of the lighting apparatus can be adapted according to the needs of a given medical therapy or scientific investigation.

A usual discharge lamp type has a spectrum according to the discharge spectrum. This is 185 and 254 nm for Hg, 172 nm for Xe, 580 to 720 nm for Ne and 172 and 580 to 720 nm for Xe/Ne. This spectrum can be converted by a luminescent screen in any other spectrum with emission bands between 280 and 800 nm. To this end, the luminescent screen is coated either onto the lamp itself or onto a glass plate, which is mounted inside the lamp. In case of tubular lamps luminescent screens can be fixed around the discharge lamps. If the luminescent screen is coated onto the light guide, i.e. onto the glass plate, quartz glass must be used since transmission in the UV range between 170 and 300 nm is required. In all other cases the light guide may consist of PMMA (polyme-thylacrylate), borosilicate or soda lime glass.

The latter lamp type emits the desired spectrum by means of a luminescent screen and is fixed inside the lamp, whereby the light is coupled into a light guide for an even distribution of the light. Light outcoupling from the light guide is achieved by a three-dimensional structuring of the light guide or by coating of nanoparticles with a diameter in the range between 5 and 250 nm onto the light guide.

The luminescent screen comprises one or several microscale luminescent compositions according to those mentioned in the table below. The luminescent screen might also comprise inorganic oxidized nanoparticles, such as Al₂O₃, MgO or SiO₂ nanoparticles, to improve the adhesion of the microparticle luminescent material to the surface. The luminescent materials are selected from the table below, whereby further luminescent compositions might be present. In Xe discharge lamps emitting in the range of 172 nm, phosphors activated by those rare earth ions can be used, which are not excitable by 254 nm radiation, e.g. LaPO₄:Tm³⁺ or LaPO₄:Dy³⁺. These materials enlarge the range of possible spectra tremendously.

| Emission | | Emission band | Colour point |
|---|---|---|---|
| Colour | Phosphor | position at [nm] | x, y |
| UV-B | SrAl₁₂O₁₉: Ce | 300 | — |
| | LaMgB₅O₁₀: Ce,Gd | 311 | — |
| | LaB₃O₆: Bi,Gd | 311 | — |
| UV-A | LaPO₄: Ce | 320 | — |
| | YPO₄: Ce | 335, 355 | — |
| | BaSi₂O₅: Pb | 350 | — |
| | Sr₂MgSi₂O₇: Pb | 365 | — |
| | SrB₄O₇: Eu | 368 | — |
| Blue | Sr₂P₂O₇: Eu | 422 | 0.167, 0.014 |
| | (Y₁₋ₓGdₓ)BO₃: Ce | 420 | 0.178, 0.159 |
| | (Y₁₋ₓGdₓ)(V_{1-y}P_{y})O₄ | 420 | 0.164, 0.143 |
| | BaMgAl₁₀O₁₇: Eu | 453 | 0.148, 0.069 |
| Blue-green | BaMgAl₁₀O₁₇: Eu,Mn | 453, 515 | 0.146, 0.195 |
| Green | BaMgAl₁₀O₁₇: Eu,Mn | 515 | 0.126, 0.650 |
| | BaAl₁₂O₁₉: Mn | 518 | 0.204, 0.717 |
| | (Ba₁₋ₓSrₓ)₂SiO₄: Eu | 523 | 0.247, 0.632 |
| | Zn₂SiO₄: Mn | 525 | 0.226, 0.709 |
| | LaPO₄: Ce,Tb | 543 | 0.352, 0.580 |
| | CeMgAl₁₁O₁₉: Tb | 544 | 0.344, 0.595 |
| | (Y₁₋ₓGdₓ)BO₃: Tb | 544 | 0.338, 0.615 |
| | InBO₃: Tb | 544 | 0.331, 0.621 |
| Yellow | (Y₁₋ₓGdₓ)₃Al₅O₁₂: Ce | 570 | 0.451, 0.532 |
| | (Sr,Ca)₂SiO₄: Eu | 580 | 0.505, 0.489 |
| Orange | (Sc₁₋ₓLuₓ)BO₃: Eu | 590 | 0.608, 0.384 |
| | (In₁₋ₓGdₓ)BO₃: Eu | 590 | 0.609, 0.385 |
| Red | (Y,Gd)BO₃: Eu | 595 | 0.638, 0.354 |
| | Y₂O₃: Eu | 611 | 0.650, 0.349 |
| | Y(V_{1-x-y}PₓNb_{y})O₄: Eu | 622 | 0.662, 0.326 |
| | GdMgB₅O₁₀: Ce,Mn | 630 | 0.662, 0.334 |
| | Mg₄GeO_{5.5}F: Mn | 656 | 0.700, 0.287 |

The lamps are fixed within the apparatus in a way to be easily replaceable. If UV emitting lamps without a luminescent screen are used, the UV lamps themselves have to be replaced. Otherwise the luminescent screens must be replaceable. This can be achieved by coated glass plates or glass tubes, which are imposed onto the UV lamps. Therefore a set of glass tubes or glass plates coated by different luminescent screens yields a flexible light source in terms of spectra.

The lighting apparatus in a further preferred embodiment might also comprise inorganic LED's, which are easy to dim and which emission spectra can be admixed to the emission spectra of the discharge lamps.

1. Lighting apparatus for medical therapy or scientific investigation comprising a set of lamps selected from the group of lamps based on Hg, Ne, Xe or Xe/Ne discharge, being replaceable by each other, in a planar structure and a light guide including a light outcoupling structure, wherein a set of luminescent screens, being replaceable by each other, for converting the spectra of the replaceable lamps into different spectra between 280 and 800 nm, is applied to the light guide, whereby the emission spectrum of the lighting apparatus can be adapted according to the needs of a given medical therapy or scientific investigation.

2. Lighting apparatus according to claim 1, characterized in that the lighting apparatus additionally comprises one or several LEDs as light sources.

3. Lighting apparatus according to claim 2, characterized in that the LEDs are based on an AlInGaN or AlInGaP semiconductor chip.

4. Lighting apparatus according to claim characterized in that the light outcoupling structure comprises a coating of nanoparticles with a diameter in the range between 5 and 250 nm.

5. Lighting apparatus according to claim 1, characterized in that the luminescent screens comprise one or several luminescent compositions selected from the group of
SrAl₁₂O₁₉:Ce, LaMgB₅O₁₀:Ce, Gd, LaB₃O₆:Bi, Gd, LaPO₄:Ce, YPO₄:Ce, BaSi₂O₅:Pb, Sr₂MgSi₂O₇:Pb, SrB₄O₇:Eu, Sr₂P₂O₇:Eu, (Y₁₋ₓGdₓ)BO₃:Ce, (Y₁₋ₓGdₓ)(V_{1-y}P_{y})O₄, BaMgAl₁₀O₁₇:Eu, BaMgAl₁₀O₁₇:Eu,Mn, BaAl₁₂O₁₉:Mn, (Ba₁₋ₓSrₓ)₂SiO₄:Eu, Zn₂SiO₄:Mn, LaPO₄:Ce,Tb, CeMgAl₁₀O₁₉:Tb, (Y₁₋ₓGdₓ)BO₃:Tb, InBO₃:Tb, (Y₁₋ₓGdₓ)₃Al₅O₁₂:Ce, (Sr, Ca)₂SiO₄:Eu, (Sc₁₋ₓLuₓ)BO₃:Eu, (In₁₋ₓGdₓ)BO₃:Eu, (Y,Gd)BO₃:Eu, Y₂O₃:Eu, Y(V_{1-x-y}PₓNb_{y})O₄:Eu, GdMgB₅O₁₀:Ce,Mn, Mg₄GeO_{5.5}F:Mn.
